(19) United States
(12) Patent Application Publication
(10) Pub. No.: US 2008/0040233 A1
(43) Pub. Date: Feb. 14, 2008

(54) Mobile order fulfillment

(76) Inventors: Thomas Alfred Wildman, Redwood City, CA (US); David William Barry, Atherton, CA (US)

Correspondence Address: HENSLEY KIM & HOLZER, LLC, 1660 LINCOLN STREET, SUITE 3000, DENVER, CO, 80264, US

(21) Appl. No.: 11/500,838

(22) Filed: Aug. 8, 2006

(51) Int. Cl. G06Q 30/00

(52) U.S. Cl. 705/26

(57) ABSTRACT

A mobile order fulfillment system communicates and processes advance orders, such that the order is ready or delivered at a time and place agreed upon in the transaction. A consumer can enter an order message into a mobile device. The order message is received and processed by an order processing server that prepares the order for transmission to a vendor. The order processing server then forwards the order to the vendor. If the vendor can commit to the order, a confirmation will be sent from the vendor to the consumer, directly or through the order processing server. Payment can be processed electronically. Provision of the product/service at the fulfillment location is timed to substantially coincide with the expected arrival of the consumer at the fulfillment location. As such, the ordering consumer's wait at the fulfillment location can be substantially reduced or eliminated.

### BACKGROUND

It is a common consumer experience to arrive at a retail establishment, such as a coffee shop, for a quick purchase only to find a line of people waiting to order and/or waiting for order fulfillment (e.g., receipt of a nice hot latté from the barista). For many consumers, this delay can be quite frustrating, particularly for commuters who are trying to get to work on time, trying to get to a bus or train on time, etc. Waiting a substantial amount of time to obtain a product or service, particularly a relatively low cost and simple product or service, is inconvenient and inefficient.

### SUMMARY

Implementations described and claimed herein address the foregoing problems by providing a system for communicating and processing advance orders, such that the order is ready or delivered at a time and place agreed upon in the transaction (e.g., made from a remote location for fulfillment at another location). In one implementation, a consumer can enter an order message into a mobile device, such as during a commute or even standing inside the vending facility. To simplify entry through the mobile device, the order may be represented by a simple order code, although other order messages are contemplated. The order message is received and processed by an order processing server that prepares the order for transmission to a vendor. The order, for example, may include without limitation a consumer identifier, a product/service identifier, a fulfillment location, a delivery location, and a fulfillment time. The order processing server then forwards the order to the vendor. If the vendor can commit to the order, a confirmation may be sent from the vendor to the consumer, directly or through the order processing server. Payment can be processed electronically, such as using a credit card account or other available fund account, or paid directly by the customer using other means of tender. Provision of the product/service at the fulfillment location is timed to substantially coincide with the expected arrival of the consumer at the fulfillment location. In this manner, the ordering consumer's wait at the fulfillment location can be substantially reduced or eliminated.

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example system for mobile order fulfillment.

FIG. 2 illustrates an example user interface to a mobile order fulfillment system.

FIG. 3 illustrates an example user interface for configuring a mobile device in a mobile order fulfillment system.

FIG. 4 illustrates an example user interface for configuring a predefined order in a mobile order fulfillment system.

FIG. 5 illustrates an example user interface for configuring a fulfillment location in a mobile order fulfillment system.

FIG. 6 illustrates an example user interface of a top level menu for configuring a product selection in a mobile order fulfillment system.

FIG. 7 illustrates an example user interface of a lower level menu for configuring a product selection in a mobile order fulfillment system.

FIG. 8 illustrates an example user interface for configuring a detailed product selection in a mobile order fulfillment system.

FIG. 9 illustrates example operations for mobile order fulfillment.

FIG. 10 illustrates example operations for validating and modifying a user and an order during mobile order fulfillment.

FIG. 11 illustrates an example user interface for a recent order log in a mobile order fulfillment system.

FIG. 12 illustrates an example user interface for a detailed recent order record in a mobile order fulfillment system.

FIG. 13 illustrates an example user interface for a detailed recent message record in a mobile order fulfillment system.

FIG. 14 illustrates modules of an example order processing server of a mobile order fulfillment system.

FIG. 15 illustrates an example system that may be useful in implementing the described technology.

### DETAILED DESCRIPTIONS

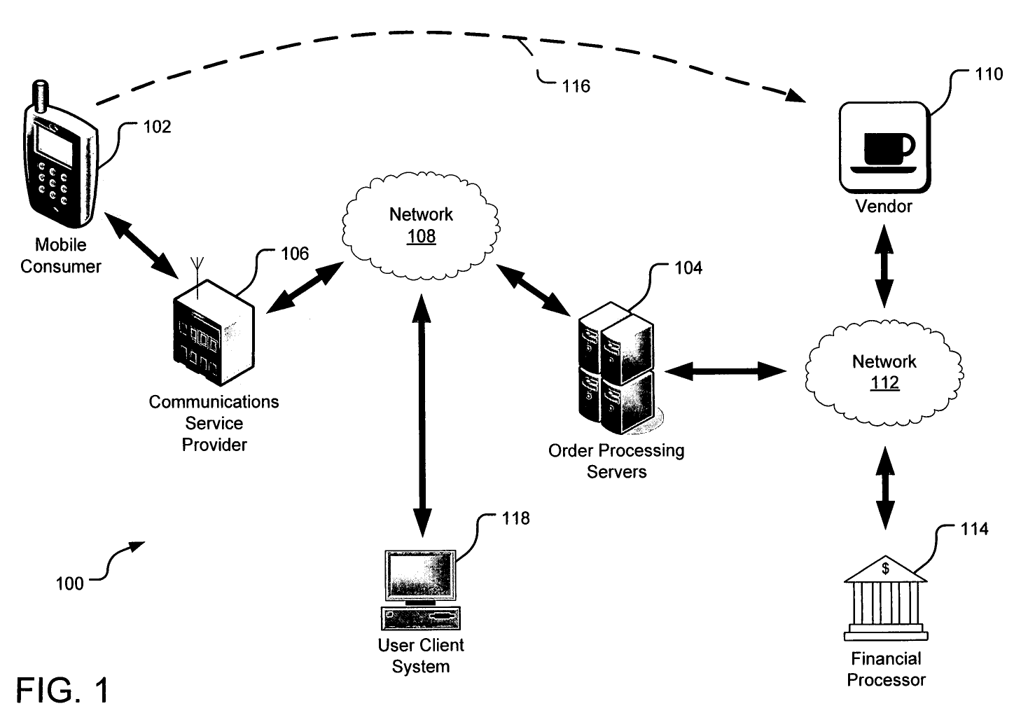

FIG. 1 illustrates an example system for mobile order fulfillment of a given resource (e.g., a product or a service). A mobile consumer 102 employs a communications device, such as a desktop computer, telephone, or mobile wireless communications device, to send an order code to an order processing server 104. The notion of being “mobile” implies that the consumer places the order at a first location (e.g., at home; in a vehicle; at the office; perhaps even inside the vending facility itself—typically not at the local order placement location like the cash register or order counter) and receives fulfillment of the order in a second location (e.g., at the coffee shop pick up counter). In one implementation, the mobile consumer 102 enters an order into a mobile phone (e.g., in the form of a Short Message Service or SMS communication, a Simple Mail Transport Protocol or SMTP communication, etc.), which is sent through a data communication service provider facility 106. For example, the mobile consumer 102 can activate an order application (e.g., an ordering client application, an SMS client, a WAP or HTML application, an email client, etc.) and input an order, which initiates transmission of the order to the order processing server 104. In order to simplify entry of the order on a mobile phone, for example, the order can be represented by a predefined order code, although orders can also or additionally be represented with other formats that can include fields such as an account identifier, a product descriptor, a product quantity value, a time stamp, a desired fulfillment or delivery time, a desired fulfillment location, order modifiers (e.g., whole milk vs. skim milk in the latté), additional order items, etc.

The data communication service provider facility 106 is coupled to a network 108 (e.g., the Internet, a telephone network, etc.) and forwards the order to the order processing server 104. The order processing server 104 receives and validates the order and processes the related order transaction with a vendor 110 through the network 112. It should be understood that the network 108 and the network 112 may be the same network (e.g., the Internet). In one implementation, the order processing server 104 can also participate in the order payment through a financial processor 114 (e.g., a bank), such as through the network 112 or other communications network. The order processing server 104 may also participate in the confirmation of the order between the vendor 110 and the mobile consumer 102. Furthermore, it should be understood that the various networks can be segregated in any variety of ways in other implementations.

As a result of the mobile ordering process, the mobile consumer 102 can physically travel (see dashed arrow 116) from the first location (e.g., the order location) to the fulfillment location, arriving at the fulfillment location at about the time the order is fulfilled. In this manner, the mobile consumer 102 can bypass waiting in line to order, waiting in line to pay, or waiting for the order to be fulfilled. It is contemplated that the mobile consumer may be at the fulfillment location already, and simply wish to avoid the order line or otherwise just wish to take advantage of the efficiencies of “remote ordering” (e.g., convenience of grabbing a table ahead of the crowd, convenience of keeping children away from the hectic order location, etc.). A mobile consumer can also indicate where the order is to be delivered or served.

In one implementation, the order processing server 104 maintain accounts for users (e.g., consumers) using the mobile order fulfillment system. A consumer can access the order processing server 104 using a user client system 118 or other access device through the network 108 or other communications network to set up his or her account, specify vendors and location, define order codes, set up payment options, establish preferences, etc. In this manner, the order processing server 104 has access to information used in preparing the order, processing the transaction with the vendor, processing the payment with the financial processor 114, etc.

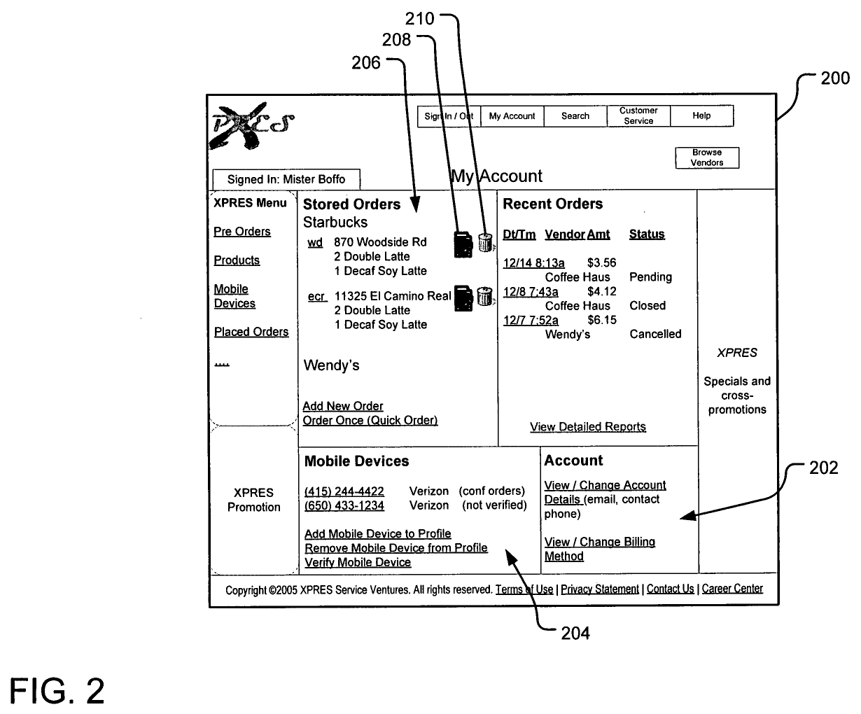

FIG. 2 illustrates an example user interface 200 to a mobile order fulfillment system. After a user logs into his or her mobile order fulfillment account, the user interface 200 allows a user to configure and review aspects of his or her account within the mobile order fulfillment system. An Account section 202 allows a user to add, view, and change user profile and billing method records for the user's account. For example, the user may select “View/Change Account Details (email, contact phone)” to gain access to a form allowing the user to view and/or change a user profile, including name, user ID, password, email address(es), confirmation method, promotional preferences, etc. Likewise, the user may select “View/Change Billing Method” to gain access to a form allowing the user to view and/or change one or more credit card entries or other payment method entries that can be used for payment of ordered products and/or services.

A Mobile Devices section 204 allows a user to add, view, and change records defining mobile devices to be used for order and confirmation communications. For example, if the device is a mobile telephone, the user may select one of the mobile devices to edit a mobile devices record, the “Add Mobile Device to Profile” to add another mobile device to the user's account, or the “Remove Mobile Device from Profile” to delete a mobile device from the user's account. The “Verify Mobile Devices” selection allows a user to instruct the mobile order fulfillment system to attempt to verify and/or activate the mobile device. In one implementation, such verification involves sending a verification code or other digital key to the specified mobile device (e.g., via an SMS message). For example, to verify the mobile device, the user can enter the verification code in a verification code field accessible through the user client system. The order processing server verifies a match between the verification code sent by the system and the verification code returned by the user, thereby authenticating the mobile device and confirming the proper set up of the communications between the order processing server and the mobile device. Other verification methods are also contemplated.

A Stored Order section 206 allows a user to add, view, and change records defining order codes. Two predefined order codes are listed in the Stored Order section 206 under the “Starbucks” heading. Note that, in the illustrated implementation, an order code (e.g., “wd”) is associated with a fulfillment location (e.g., a Starbucks at 870 Woodside Rd.) and a product selection (e.g., 2 double lattés and a decaf soy latté). Other order codes can be listed in the scrollable section. These other order codes can be associated with a different fulfillment location and/or a different vendor. A control 208 provides access to a form for editing the order codes, and another control 210 deletes an order code from the account.

Having set up various order codes through his or her account, a user can place an order through one of the registered mobile devices in Mobile Device section 204, or through an unregistered device that can otherwise authenticate the user. For example, in one implementation, by sending an SMS message “wd” to the order processing server, the user can order the three specified products. The order processing server can be identified by a destination identifier (e.g., a phone number, an email address, a URL, etc.). In one implementation, a speed dial feature can be employed to facilitate entry of the destination identifier. In addition, the user can append modifiers to the SMS messages, such that “wd 730a” may specify that the user wants the order fulfilled at 7:30 AM, or “wd+med latte” may specify that an additional medium-sized latte is to be added to the order. After processing the order, the vendor can confirm, modify, or decline the order (as discussed below). In one implementation, the user can cancel a confirmed or modified order within a defined cancellation window.

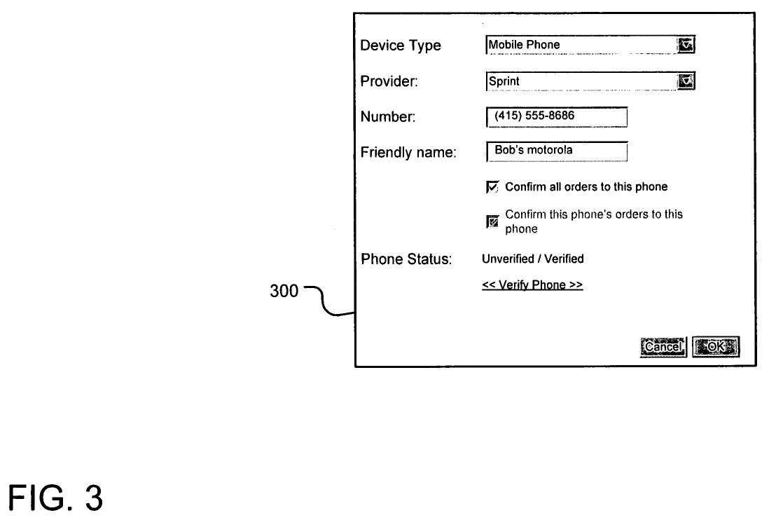

FIG. 3 illustrates an example user interface 300 for configuring a mobile device in a mobile order fulfillment system. The user interface 300 includes form fields and settings for the mobile service provider, the mobile phone number, a mnemonic label for the mobile device record, confirmation instructions, and phone verification status. Other form fields and settings combinations are contemplated in alternative implementations. In the example of FIG. 3, the mobile device is represented by a mobile telephone. However, in other implementations, the mobile device could be any remote communications system usable by the mobile consumer, including a laptop computer, a set-top box, a desktop computer, a kiosk, etc.

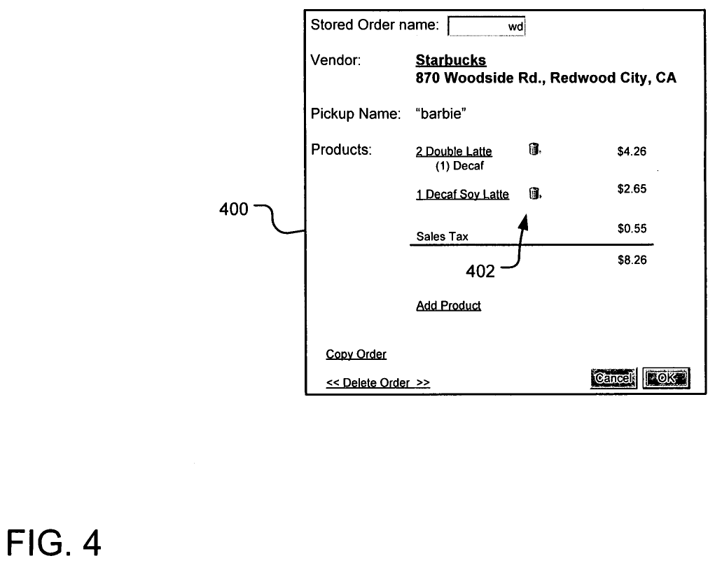

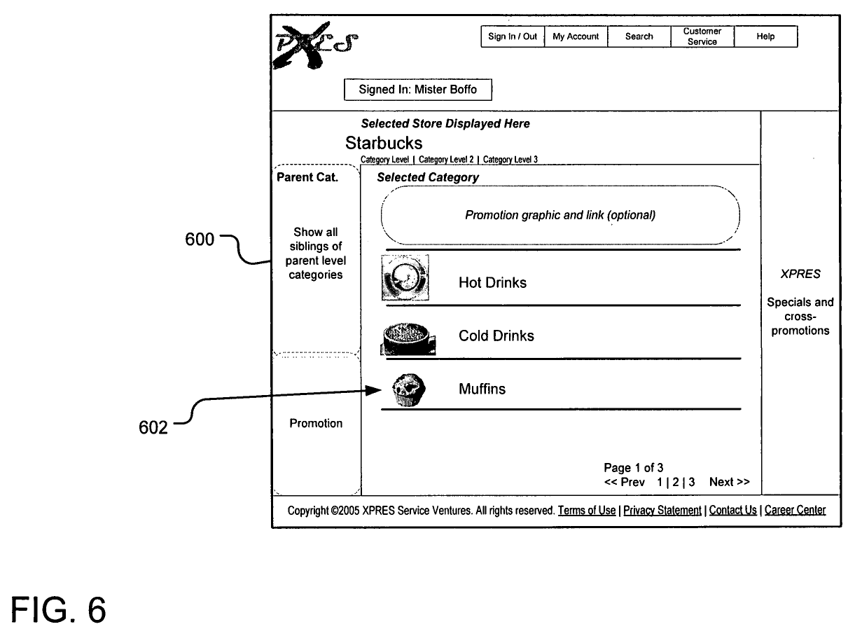

FIG. 4 illustrates an example user interface 400 for configuring a predefined order in a mobile order fulfillment system. The user interface 400 includes form fields and settings for the order code “wd”, including without limitation the vendor and fulfillment location, a name associated with the receipt of the product or service at the fulfillment location (e.g., “2 double lattés and a decaf soy latté for Barbie”), product prices, sales tax, sales total, etc. In an alternative implementation, the order need not be associated with an order code, although this arrangement can facilitate entry and submission of an order through a mobile device, particularly when commuting. The “Add Product” control allows a user access to a product selection screen (see e.g., FIG. 6). A control 402 deletes a product from the order code. The “<<Copy Order>>” control creates a copy of the selected stored order code as the basis for creating a new stored order. For example, the user can copy an existing order code and modify its parameters to create a new order code. The “<<Delete Order>>” control deletes the stored order from the account data.

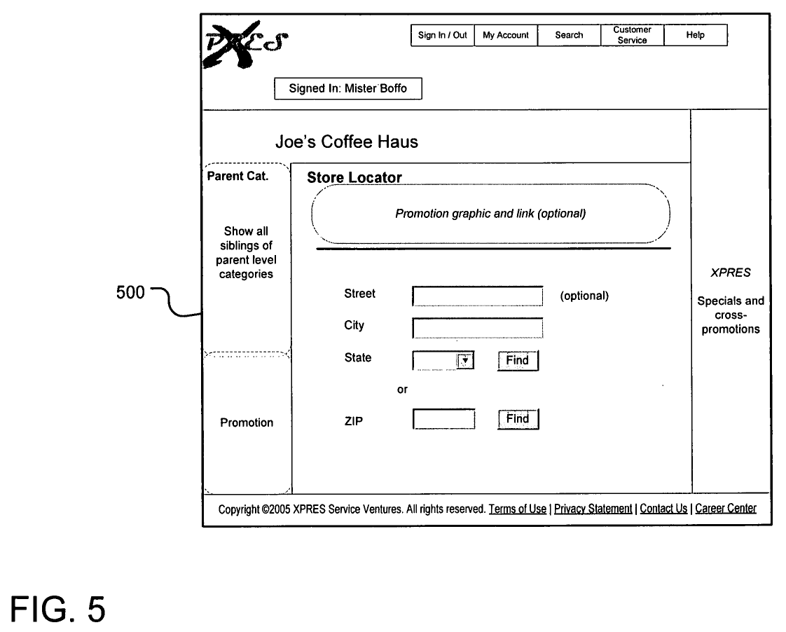

FIG. 5 illustrates an example user interface 500 for configuring a fulfillment location in a mobile order fulfillment system. In one implementation, when defining a stored order, the user can access a list of supported vendors (not shown). By selecting one of the vendors, a display similar to the user interface 500 is presented to the user to assist with locating a fulfillment location associated with the selected vendor. Locations in a location database of the order processing server can be searched by global position coordinates, address and/or zip code, although other search methods are contemplated. The search results (e.g., those locations in the proximity of the provided address or zip code) are presented in a “Select Store” form with a numbered list of possible fulfillment locations and a map of the locations in the proximities. From this “Select Store” display, the user can select a specific fulfillment location to associate with the order code. In response to a selection, the specific address, store hours, and driving directions are made accessible to the user. In alternative implementation, the user need not specify a specific fulfillment location, and the system will display one or more appropriate fulfillment locations at the time the order placed or accepted by the vendor.

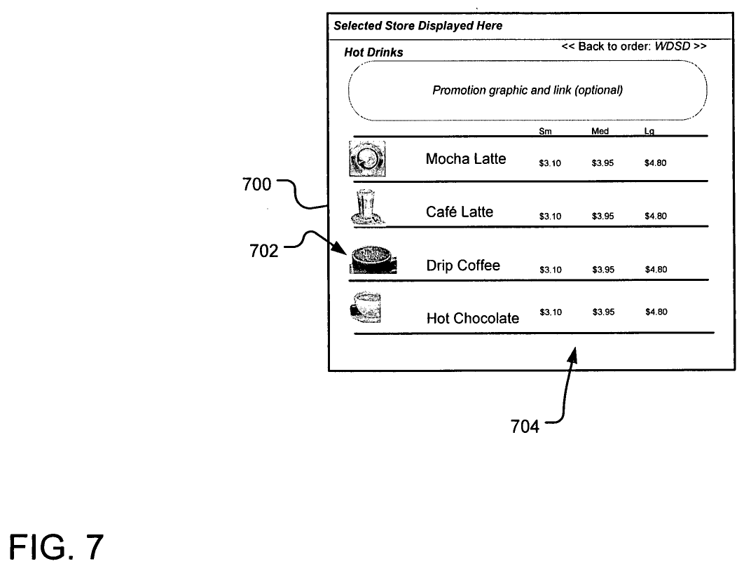

FIG. 6 illustrates an example user interface 600 of a top level menu for configuring a product selection in a mobile order fulfillment system. By selecting a product control 602, the user can navigate to a more detailed menu (see e.g., FIG. 7).

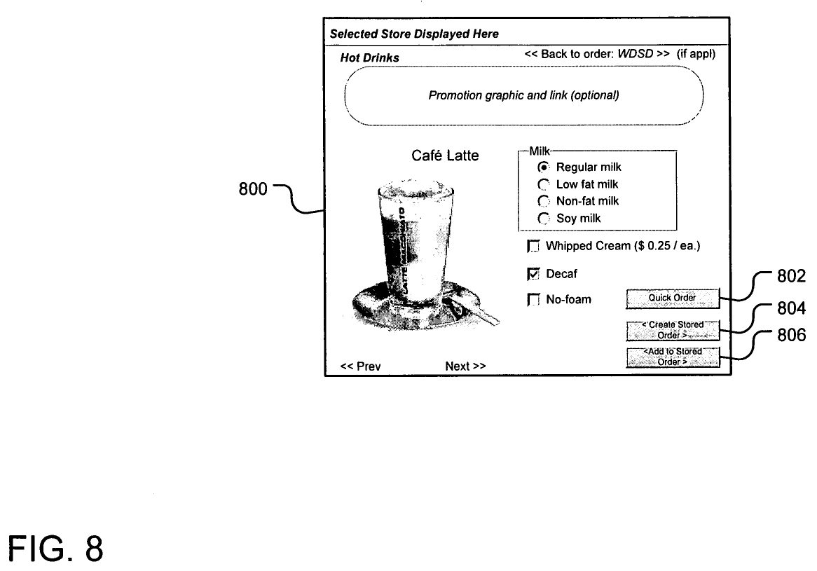

FIG. 7 illustrates an example user interface of a lower level menu 700 for configuring a product selection in a mobile order fulfillment system. By selecting a specific product control 702, the user can navigate to a more detailed menu (see e.g., FIG. 8). Prices for different sizes/quantities of the specific products are displayed in the table 704.

FIG. 8 illustrates an example user interface 800 for configuring a detailed product selection in a mobile order fulfillment system. In the example shown in user interface 800, the user can select from 4 different kinds of milk and specify whipped cream, decaffeinated coffee, and/or no-foam, if desired. Using the Quick Order control 802, the user can order directly through the user interface, without requiring use of a predefined order code on a mobile device. Using the “Create Stored Order” control 804, the user can load the selected product into a new order code. Using the “Add to Stored Order” control 806, the user can add the selected product to the current order code.

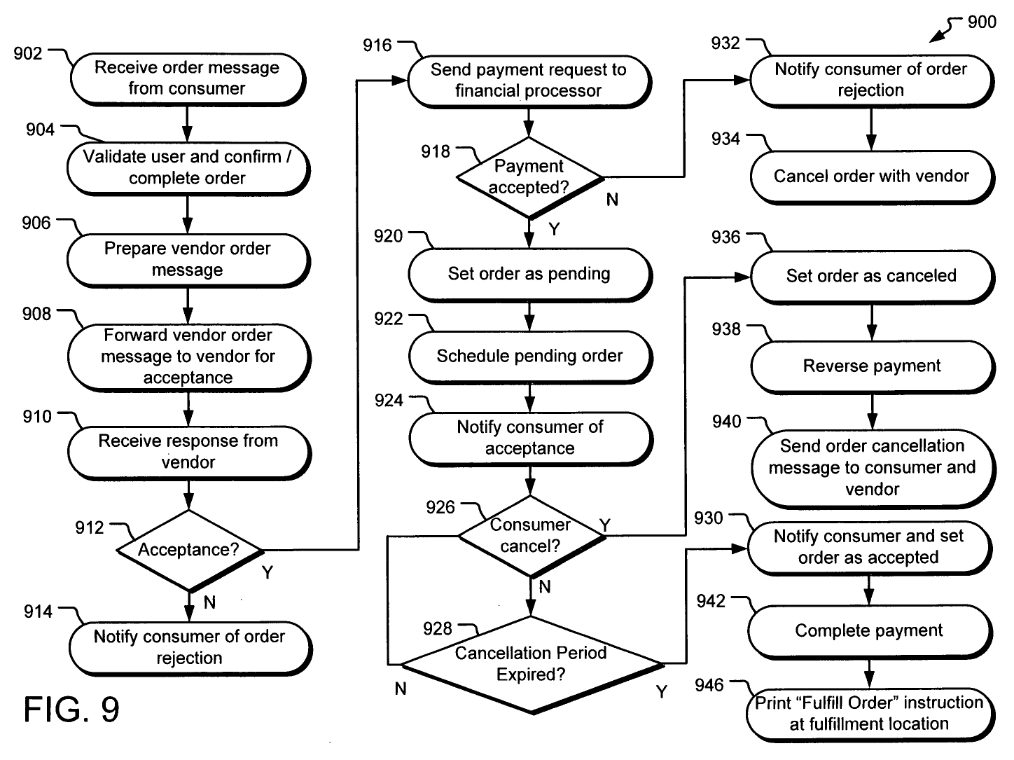

FIG. 9 illustrates example operations 900 for mobile order fulfillment. A receiving operation 902 receives an order message from a consumer. The consumer is at a different location than the location at which the order will be fulfilled, although both locations may be in close proximity (e.g., both might be at different locations within the same coffee shop). Typically, however, the consumer is using the mobile order fulfillment to bypass a delay related to waiting in an order line or fulfillment line.

In one implementation, the order message includes a predefined order code. For example, a mobile consumer can activate an order application using a communications device and specify an order code for transmission, e.g., as an SMS message, an email, a phone call, etc. An example order message is given below, although others are contemplated:

TABLE 1
Example Order Message Field

| Order Field | Description | Example Data |
|---|---|---|
| caller_id | Identifies mobile device sending the order | 415-555-1234 |
| | message | |
| order code | Specifies the order code that is defined in | “chm 730a” |
| | the stored order table of the order | |
| | processing server, with optional modifiers | |

An order processing server can receive the order message from the mobile consumer's communication device. In one implementation, the order message specifies data that allows the order processing server to construct an order. For example, the order message can specify some or all of the data fields required for the order, where any missing data can be developed from the user account or another database accessible to the order processing server. The missing data can also be obtained by sending queries for the missing information to the user. Alternatively, the order message can be in the form of an order code, which the order processing server can use to look up a predefined order code associated with the consumer's account. If an order code is provided, the order processing server can translate the order code into an order as an action component of generating of a vendor order code. For example, the order code can be looked up in an order code table associated with the user, a vendor, etc. and then corresponding order parameters may be returned for generating a vendor order message.

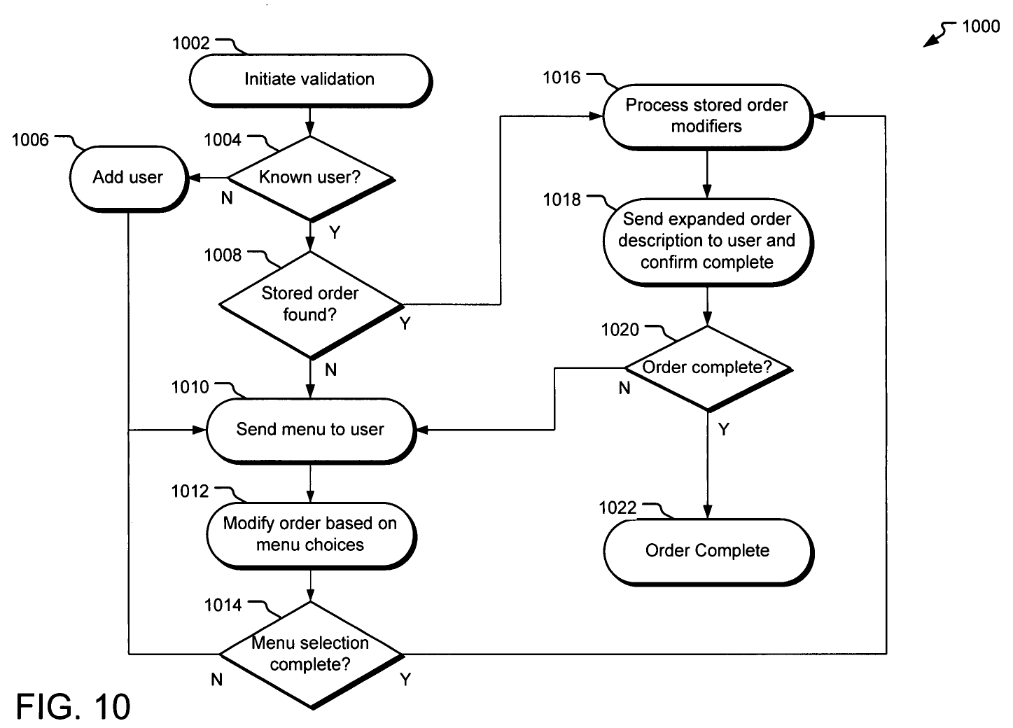

A validation operation 904 evaluates the order message received from the consumer to validate the order according to its user accounts, product database, order code database, vendor database, and/or other datastores. In one implementation, the validation operation 904 prepares the valid order payload, based on the order message. For example, the validation operation 904 may determine a key to an appropriate user account record, (account_id) based on the received caller ID, and a key to an appropriate stored order record (order_id) based on the order code. In one implementation, the caller ID is searched through the mobile device records to identify an appropriate user account record key, and the order code is searched through the stored order records to identify an appropriate order record key. If the ordering consumer cannot be verified in the mobile device records, a new account setup operation may be initiated on the remote device (see operation 1006 in FIG. 10). The validation operation 904 can also determine the receipt time of the order message. Alternatively, a user account record key can be located using an email address or other proxy. Likewise, the order code can be replaced with a full or partial order payload, generated by the mobile device client.

If the order message includes modifiers, the validation operation 904 processes the modifiers. For example, given the modifier “730a”, the validation operation 904 interprets the modifier to specify a requested fulfillment time of 7:30 AM on the current day. Other order modifiers may be used to change, add, or remove items from the order. The validation operation 904 creates an order payload record reflecting information represented by or derived from the order.

TABLE 2
Example Order Payload Record Fields

| Field | Description | Example Data |
|---|---|---|
| account_id | Identifies the user account associated with | 18563 |
| | the order | |
| order_id | Identifies an order among all other orders | 456 |
| | placed by the system | |
| received_time | Identifies the date and time the order was placed | 1/4/06 7:14 AM |
| requested_ready_time | Identifies the time that the consumer | 1/4/06 7:30 AM |
| | requests the order to be ready | |
| ready_time | Identifies the time that the vendor commits | 1/4/06 7:33 AM |
| | to having the order ready | |
| authentication | Identifies the method or code used to | “Joe Z” |
| | authenticate the order with the consumer | |
| order_message | Specifies the order message received from | “chm 730a” |
| | the client | |

If the caller ID, in the case of a mobile phone being used as the mobile device, or some other user proxy is not found in the mobile device (or user proxy) records, the user is not authenticated and the order fails. In reaction to such a failure, the order processing server may send a failure response to the mobile device. As such, the validation operation 904 can examine the order message to ensure that the order was submitted by an authorized user. An example user account record is described below and is associated with mobile device or user proxy records (not shown):

TABLE 3
Example User Account Record Fields

| Field | Description | Example Data |
|---|---|---|
| account_id | A user identifier associated with the | 18563 |
| | account | |
| username | A login name for the user account | Jdoe |
| password | A password to the user account | 1/4/06 7:14 AM |
| first_name | User's first name | “John” |
| last_name | User's last name | “Doe” |
| preferred_cc_friendly_name | Text string describing credit card | “amex_gold” |
| Address1 | Billing address 1 of credit card | 145 Main St. |
| Address2 | Billing address 1 of credit card | Apartment 15 |
| City | Billing address city | St. Louis |
| State | Billing address state | MO |
| Zip | Billing address zip code | 53457 |
| email_address1 | Email address for correspondence and/or | jdoe88@yahoo.com |
| | receipt of order confirmations | |
| email_address2 | Alternative email address for | jdoze@aol.com |
| | correspondence and/or receipt of order | |
| | confirmations | |
| order_confirmation_method | The method to be used in confirming the | SMS |
| | order after order is sent to vendor | |

The validation operation may also validate the order message, for example, by verifying: that an order code matches a predefined stored order record available to the user (see operation 1008 in FIG. 10); that the vendor identified for the fulfillment is available to the user (see operation 1004 in FIG. 10); that the product requested is provided by a valid vendor (see operation 910 in FIG. 9); that the fulfillment location is valid (see operation 910 in FIG. 9); etc. An example stored order record is given below:

TABLE 4
Example Stored Order Record Fields

| Field | Description | Example Data |
|---|---|---|
| dbo_stored_order.id | Identifies the stored order record | 2 |
| | uniquely (may be system generated) | |
| account_id | Identifies a user associated with the | 18563 |
| | account | |
| Stored_order_name | Identifies an order (an order code) | “chm” |
| Stored_order_description | Mnemonic description of the stored | “Morning mocha @ |
| | order | the haus” |
| all_or_nothing | If the order consists of more than one | FALSE |
| | item, but vendor is not capable of | |
| | providing all at the time of order, the | |
| | order is to be rejected by the vendor. | |
| dbo_stored_order_item.id | References the item(s) in the product | 1 |
| | database that constitute the stored | |
| | order | |
| Stored_order_id | References the parent stored order | 2 |
| | record | |
| order_item_index | Identifies an index of the item, which | 1 |
| | determines the placement of the item | |
| | within the displayed item list | |
| substitute_for_order_item_id | If one item that makes up the stored | 0 |
| | order is unavailable at the time of | |
| | ordering, this item may be used as a | |
| | substitute. | |
| product_quantity | Number of items in order | 1 |
| Vendor_id | Identifies a vendor record associated | 2 |
| | with the stored order | |
| price_record_set | References the price record in effect | 1/1/06 12:00 AM |
| | at the time the order was modified | |
| | (useful for dispute resolution) | |
| dbo_stored_order_item.product_id | A key referencing a product record | 4 |
| | in a product database associated with | |
| | the specified vendor | |
| Stored_order_item_id | The unique record identifier for this | 1 |
| | stored order item (may be system | |
| | generated) | |

In one implementation, if a known, valid stored order message is not received with the order message from the user, or if the user wishes to modify the order prior to placement, user interface communications (e.g., providing a series of menus) can be sent from the order processing server to prompt the user. The user can supplement and/or modify the order message using the user interface, and the resulting responses can then be evaluated so that a vendor can be selected and a complete and valid order can be taken from the user. The menus may be built from the information store that is used to construct the preorders.

If the order has been validated, a preparation operation 906 generates a vendor order message for transmission to the vendor, based on the order payload. In one implementation, the vendor order message is formatted in XML, although other formats may be employed. To generate the vendor order message, the preparation operation 906 extracts relevant data from the account record, the stored order record, the order payload, etc. The preparation operation 906, therefore, would extract the order data from the user's account, update the order with the modifications made at the time the order was placed, and assemble some or all of the order data into a vendor order message for transmission to the specified vendor. An example order message is provided below:

TABLE 5
Example Vendor Order Message

```
<?xml version=“1.0” encoding=“UTF-8”?>
<order>
  <Order_ID>100345</Order_ID>
  <vendor_id>0305</vendor_id>
  <vendor_name>Pacos Sandwich Shop</vendor_name>
  <vendor_location>1421 Del Mar, San Diego</vendor_location>
  <send_order_address>192.168.44.26</send_order_address>
  <label_name>Skipper</label_name>
  <received_time>2006-01-05T07:12:04</received_time>
  <requested_ready_time>2006-01-05T07:34:00</
  <requested_ready_time>
    <Order_Items>
      <item_no>1</item_no>
      <vendor_product_id>16</vendor_product_id>
      <product_name>Cabo Chicken</product_name>
      <product_quantity>2</product_quantity>
      <product_price>0</product_price>
      <product_options>
        <product_option_id>44</product_option_id>
        <option_description>small</option_description>
        <option_price>3.49</option_price>
      </product_options>
    </Order_Items>
    <Order_Items>
      <item_no>2</item_no>
      <vendor_product_id>12</vendor_product_id>
      <product_name>Honey Bacon Club</product_name>
      <product_quantity>1</product_quantity>
      <product_price>0</product_price>
      <product_options>
        <product_option_id>33</product_option_id>
        <option_description>medium</option_description>
        <option_price>4.29</option_price>
      </product_options>
      <product_options>
        <product_option_id>35</product_option_id>
        <option_description>custom</option_description>
        <option_price>0</option_price>
        <response>no mayonnaise</response>
      </product_options>
    </Order_Items>
</order>
```

The table below describes some available fields in an example vendor order message.

TABLE 6
Example Vendor Order Message Fields

| Field | Description | Example Data |
|---|---|---|
| ORDER | | |
| dbo_order_id | Unique identifier of the order (may be | 1 |
| | system generated) | |
| vendor_id | Unique identifier of the vendor or | 2 |
| | fulfillment location (may be system | |
| | generated) | |
| vendor_location | Physical address of the vendor or | 123 Maple Street |
| | fulfillment location | Denver, CO 80264 |
| send_order_address | Network address of vendor | 192.168.44.26 |
| label_name | The name the consumer wishes to have | Tom W. |
| | printed on the label that will be affixed to | |
| | or associated with the vended order at the | |
| | fulfillment location. | |
| received_time | The date and time the order was received | 1/4/06 7:14 AM |
| | by the order processing server | |
| requested_ready_time | The date and time the user requests | 1/4/06 7:30 AM |
| | fulfillment | |
| ORDER ITEMS | | |
| item_no | The unique identifiers of this item within | 2 |
| | the order (e.g., a numerical index) | |
| vendor_product_id | The vendor's internal product code for | 346565-32 |
| | this item within the order | |
| product_name | Descriptive product name that the vendor | Tall mocha latté |
| | recognizes | |
| product_quantity | Number of items in order | 1 |
| product_price | Product Price | 3.95 |
| PRODUCT OPTIONS | | |
| product_option_id | Reference to the detailed records of this | 35 |
| | product's options in the product database | |
| option_description | Vendor-recognized description of the | No Whip |
| | product option | |
| option_price | Price of the product option, in addition to | 0.00 |
| | product price | |
| response | A user-supplied response to this product | Extra Hot |
| | option, if applicable. Used for | |
| | descriptive-type options, to which a list | |
| | selection mechanism is not applicable | |

A forwarding operation 908 transmits the vendor order message to a vendor associated with the fulfillment location specified in a vendor record accessible to the mobile fulfillment system. In one implementation, the forwarding operation 908 transmits the vendor order message using the communications address specified in the send_order_address field of the vendor order message. In one implementation, the vendor order message is sent to the fulfillment location in XML format over TCP/IP, although other methods are contemplated, including FTP, HTTP, etc.

A receipt operation 910 receives a response from the vendor. If the vendor has declined the order (operation 912), a notification operation 914 notifies the user of the order rejection (e.g., through an SMS message to the user's mobile device). If the vendor has accepted the order (operation 912), a payment request operation 916 sends a payment request, built from a credit card record (not shown) associated with the user account record, to a financial processor (e.g., PAYPAL).

A vendor may reject an order based on any number of factors, including without limitation inadequate stock, store hours, backlog, etc. Some or all of the factors that influence and result in an order rejection may be stored by the vendor in the information store, and therefore, may not require manual acceptance or rejection of any message. For example, the vendor may specify in the information store certain hours during which mobile orders are accepted. If a mobile order is received outside of those specified hours, the order processing server can merely send an order rejection back to the consumer.

In another implementation, if the vendor cannot fulfill the order, the vendor may suggest replacement item(s) or modifiers for the order in attempt to satisfy the user's request. For example, the vendor can respond with an order rejection but specify replacements or modification in a user interface communication (e.g., menu prompts). This alternative allows the user to cooperate with the vendor to identify a potentially satisfactory resource.

If the financial processor rejects the payment request (operation 918), a notification operation 932 notifies the user of the order rejection (e.g., through an SMS message to the user's mobile device) and a cancellation operation 934 cancels the order with the vendor. If the financial processor has accepted the order (operation 918), a setting operation 920 sets the order as “pending” in a state field of the order, in which state it remains until expiration of the time period allowed by the system for cancellations. The time period (also referred to as a cancellation window) can be set or influenced by the vendor and/or it can be dependent upon the requested fulfillment time, or some other order parameter.

A scheduling operation 922 schedules the order and synchronizes the schedule with the vendor's other orders. In various implementations, however, orders received by the vendor may or may not be synchronized with orders taken by the vendor through other means, e.g. point of sale (POS) systems. Such systems may have and make available order delay parameters that are used to determine order fulfillment times based on real-time parameters, such as order backlog, payment processing times, or other deterministic variables. In addition to real-time, POS and deterministic delay parameters, vendors may use an onsite interface to manually specify order fulfillment times and order cancellation time. A delay may also be introduced by the vendor, such that the order can be placed by the consumer and received by the vendor, but the vendor introduced a delay period prior to fulfillment. In this manner, an order can be fully processed and confirmed, with the payment completed, but the vendor can introduce a delay to the fulfillment in order to more closely satisfy the fulfillment time.

An order acceptance message, which may also include a cancellation period allowed by the vendor, is sent to the consumer in a notification operation 924. If the order is cancelled by the consumer within the vendor-allowed period of time (operations 926 and 928), a setting operation 936 sets the order as “cancelled” in a state field of the order, the order is removed from the scheduling system (operation 937), the payment is reversed (operation 938), and cancellation confirmation messages are sent to the consumer and the vendor (operation 940). If the consumer attempts to cancel the order after the cancellation period has lapsed, the consumer is sent a message that the order cancellation period has lapsed, and cancellation is not possible (not shown). If the order cancellation period lapses without cancellation, the consumer is sent a message that the order is being fulfilled and the system sets the order state as “accepted” (operation 930). A payment operation 942 completes the payment transaction with the financial processor. A presentment operation 946 presents (e.g., prints or displays) the “fulfill order” instructions at the fulfillment location. In one implementation, for example, the personnel at the fulfillment location view the presented fulfill order instructions and prepare the ordered resource for receipt by the consumer.

At this point, the vendor proceeds with fulfillment of the order through the vendor's internal processes, and the consumer arrives at the fulfillment location to receive the result of the order. In one implementation, a label may be affixed to or associated with the vended resource to identify the consumer for whom the resource is intended. In alternative implementations, another identification system is employed to match the vended resource with the appropriate consumer (e.g., the resource may be shipped to a delivery address, an example fulfillment location).

Vendor acceptance of an order may be with or without conditions. For example, the user may have requested fulfillment at 7:30 AM, but the fulfillment location could not complete the fulfillment until 7:33 AM. As such, the vendor communicates a committed fulfillment time to the order processing server in an acceptance communication (see decision operation 912 in FIG. 9). The order processing server then communicates the committed fulfillment time to the user in notification operation 924. If the user is not satisfied with the expected fulfillment time, the user can send a cancellation message responsive to the notification with a predefined cancellation window, which can be set according to terms in the mobile order fulfillment service agreement. For example, a user may be given 2 minutes after confirmation in which to cancel an order before the payment is completed.

It should be understood that a variety of communication protocols and sequences may be employed among the user, the order processing server, the vendor, and the financial processor. For example, in another implementation, the vendor may communicate acceptance directly to the user via an SMS message or other communication. In such an implementation, the vendor can also send the acceptance to the order processing server. In yet another implementation, the vendor has responsibility for processing the payment, such as by receiving a credit card number, authentication information, and/or a vendor-supplied account identifier.

FIG. 10 illustrates example operations 1000 for validating and modifying a user and an order during mobile order fulfillment. An initiation operation 1002 initiates the validation operation. A decision operation 1004 determines whether the user is known (e.g., whether a user identifier, such as a caller ID, is found in the information store). If not, the user can be added in a new user operation 1006, and then processing proceeds to send a user interface communication to the new user in a menu operation 1010.

If the user is known, then there may be stored orders available in the information store, as determined by a decision operation 1008. If not, processing proceeds to send a user interface communication to the new user in the menu operation 1010. Otherwise, processing proceeds to an order processing operation 1016, which processes the order modifiers. A confirmation operation 1018 generates a description of the ostensibly complete order and sends it to the user for confirmation. If the user does not confirm the order, processing proceeds to send a user interface communication to the new user in a menu operation 1010. In this manner, the user can revise the order. Otherwise, the order is deemed complete in a complete operation 1022.

If the user receives a menu from the menu operation 1010, a user interface communication sends prompts to the user (or some other inquiry) to obtain additional, replacement, or corrective order parameters. Based on the user's response, a modification operation 1012 modifies the order. If the user wishes to continue modifying the order in decision operation 1014, processing returns to the menu operation 1010. Otherwise, processing proceeds to the order processing operation 1016, which processes the order modifiers. Processing then continues with the confirmation operation 1018.

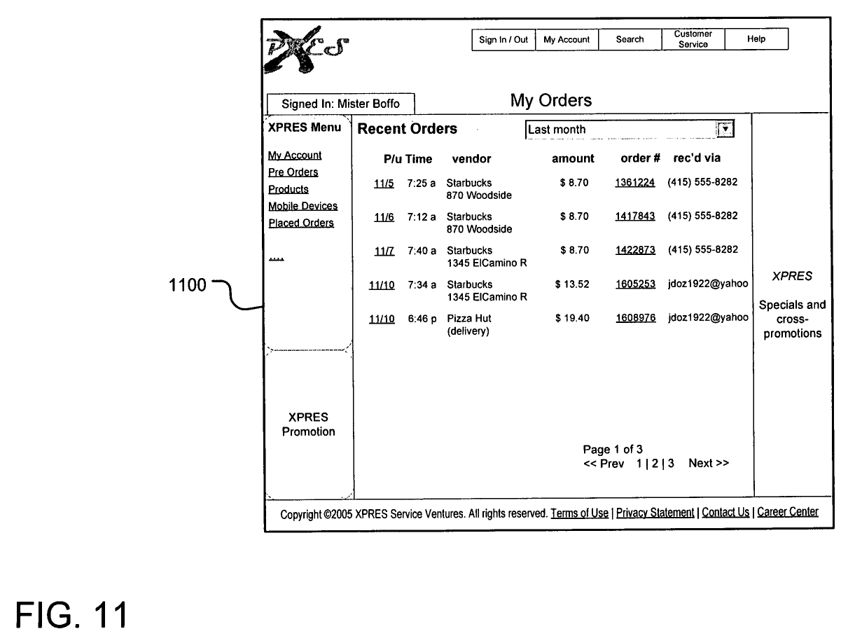

FIG. 11 illustrates an example user interface 1100 for a recent order log in a mobile order fulfillment system. Through such user interface 1100 executing on a desktop computer, for example, the user can view details of recent orders, including the date, time, vendor, cost amount, a system-provided order number, and an indication of the confirmation mechanism used for the order. Other fields available in association with the user account, the stored order, the payment database, etc. may also be presented.

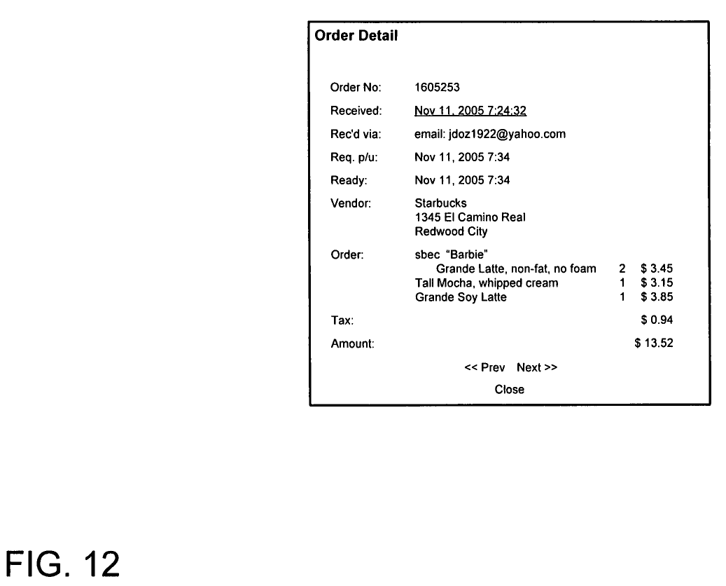

FIG. 12 illustrates an example user interface 1200 for a detailed recent order record in a mobile order fulfillment system. By selecting an order number from user interface 1100 of FIG. 11, the user can view details of a selected order.

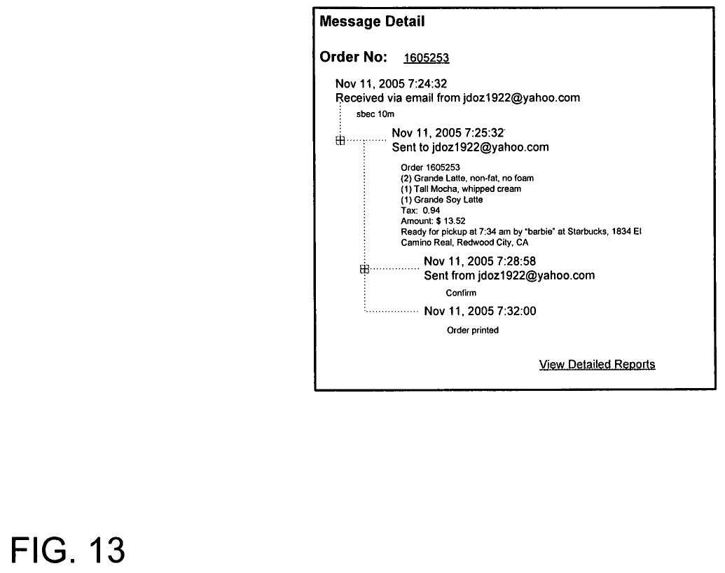

FIG. 13 illustrates an example user interface 1300 for a detailed message series in a mobile order fulfillment system. Communication to or from the consumer or vendor is conducted and retained in the form of messages. By selecting the Received date and time control in the user interface 1200 of FIG. 12, the user can view details of communications relating to the order 1605253, including without limitation the order message, the order confirmation from the vendor, another confirmation from the user, and notice of the completion of the order by the vendor (in anticipation of fulfillment).

Other messages that relate to the order might include order cancellation (by the consumer, the vendor, or the service operator) and acknowledgements, order modifications, clarifications, order status inquiries, and messages promoting or soliciting goods or services. In the interface shown, messages are displayed hierarchically, in message “threads”, which allows the user to ascertain the sequence of the messages. The languages and protocols used to encode and digitally transfer the message from the sender and receiver may include, without limitation, XML, HTML, or a proprietary format.

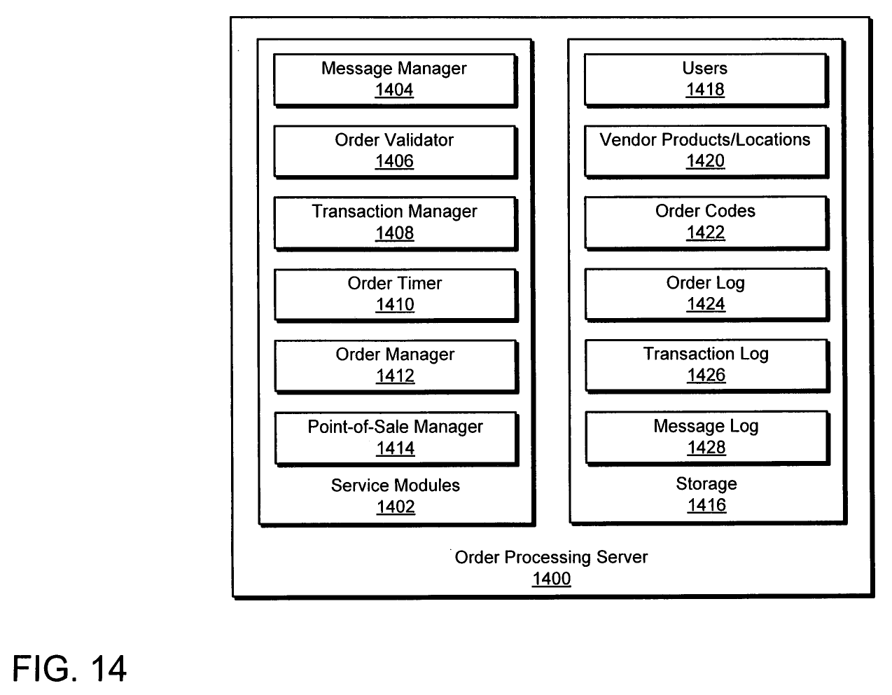

FIG. 14 illustrates modules of an example order processing server 1400 of a mobile order fulfillment system. The functional service modules 1402 include, without limitation, a message manager 1404 that stores and routes messages from the sender (consumer or vendor) to the receiver (vendor or consumer). An order validator 1406 authenticates the order as being from the designated consumer and checks that the resources being ordered are valid and correct. If the order is not valid, interaction with the consumer may be employed to correct the problem. A transaction manager 1408 processes payment of the validated order. An order timer 1410 manages order processing (and order cancellation, if applicable), ensuring that the order reaches the vendor for fulfillment at the correct time. An order manager 1412 provides a user interface for user-management, creation, deletion, and editing of order codes and associated orders. A point-of-sale manager 1414 provides an interface for managing the order relative to the vendor. The point-of-sale manager 1414 can also provide order summaries, product, and financial reporting to the vendor.

In one implementation, data storage for the example order fulfillment system 1416 may include, without limitation, user data 1418, vendor product/location data 1420, order codes data 1422, an order log 1424, a transaction log 1426, and a message log 1428. The user data 1418 includes consumer identification, authentication, and payment source information, as well as individual mobile device configuration. The vendor products/locations data 1420 includes, for each vendor or group of vendors, locating information, product catalogs, promotions, and pricing. The order codes data 1422 includes each of the stored order codes and respective constituents for each user. The order log 1424 includes data that describes each of the orders placed with the system, including the vendor, products and prices that comprise the order; The transaction log 1426 includes the time-stamped financial records associated with the orders, including charges, credits, accounts, and prepayments. The message log 1428 includes records of messages that are associated with various orders (e.g., see messages described herein).

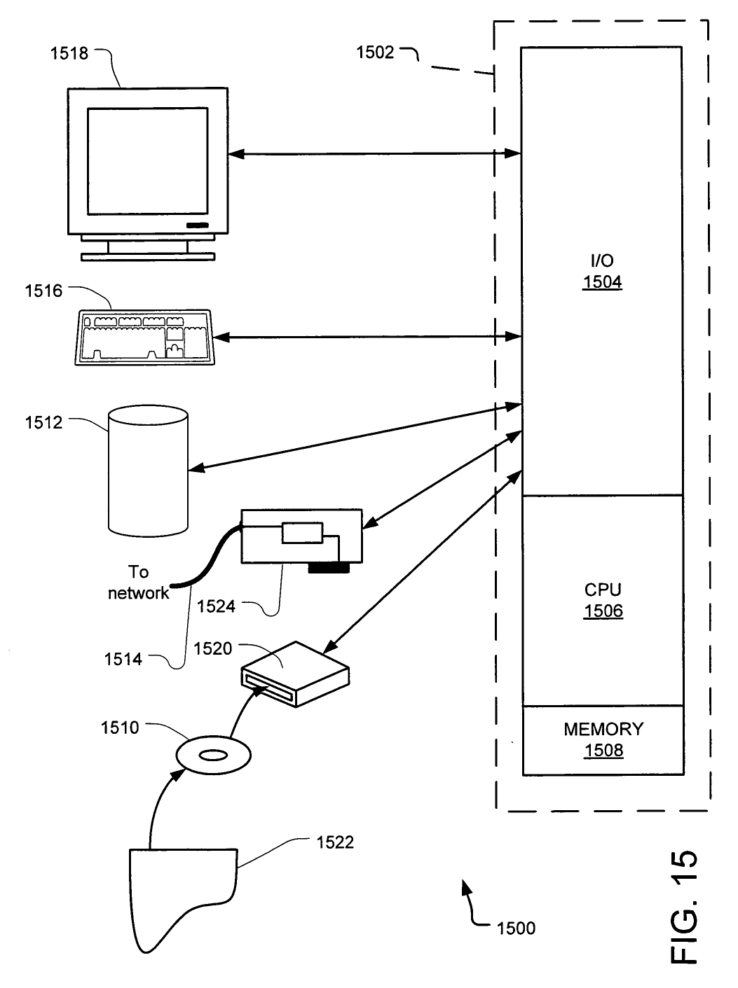

FIG. 15 illustrates an exemplary system useful in implementations of the described technology. A general purpose computer system 1500 is capable of executing a computer program product to execute a computer process. Data and program files may be input to the computer system 1500, which reads the files and executes the programs therein. Some of the elements of a general purpose computer system 1500 are shown in FIG. 15 wherein a processor 1502 is shown having an input/output (I/O) section 1504, a Central Processing Unit (CPU) 1506, and a memory section 1508. There may be one or more processors 1502, such that the processor 1502 of the computer system 1500 comprises a single central-processing unit 1506, or a plurality of processing units, commonly referred to as a parallel processing environment. The computer system 1500 may be a conventional computer, a distributed computer, or any other type of computer. The described technology is optionally implemented in software devices loaded in memory 1508, stored on a configured DVD/CD-ROM 1510 or storage unit 1512, and/or communicated via a wired or wireless network link 1514 on a carrier signal, thereby transforming the computer system 1500 in FIG. 15 to a special purpose machine for implementing the described operations.

The I/O section 1504 is connected to one or more user-interface devices (e.g., a keyboard 1516 and a display unit 1518), a disk storage unit 1512, and a disk drive unit 1520. Generally, in contemporary systems, the disk drive unit 1520 is a DVD/CD-ROM drive unit capable of reading the DVD/CD-ROM medium 1510, which typically contains programs and data 1522. Computer program products containing mechanisms to effectuate the systems and methods in accordance with the described technology may reside in the memory section 1504, on a disk storage unit 1512, or on the DVD/CD-ROM medium 1510 of such a system 1500. Alternatively, a disk drive unit 1520 may be replaced or supplemented by a floppy drive unit, a tape drive unit, or other storage medium drive unit. The network adapter 1524 is capable of connecting the computer system to a network via the network link 1514, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1500 is connected (by wired connection or wirelessly) to a local network through the network interface or adapter 1524, which is one type of communications device. When used in a WAN-networking environment, the computer system 1500 typically includes a modem, a network adapter, or any other type of communications device for establishing communications over the wide area network. In a networked environment, program modules depicted relative to the computer system 1500 or portions thereof, may be stored in a remote memory storage device. It is appreciated that the network connections shown are exemplary and other means of and communications devices for establishing a communications link between the computers may be used.

In an exemplary implementation, order timers, order validators, transaction managers, message managers, and other modules may be incorporated as part of the operating system, application programs, or other program modules. Orders logs, products databases, user databases, order code databases, transaction logs, and other data may be stored as program data.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method of processing an order for a resource, wherein the order is initiated by a consumer through a communications device, the method comprising:
receiving from the communications device an order code associated with the order for the resource, the order code being entered by the consumer into the communications device;
translating the order code to generate a vendor order message specifying the resource and a fulfillment location;
transmitting the vendor order message to a vendor to request fulfillment of the order at the specified fulfillment location; and
receiving an acceptance of the order by the vendor, wherein the acceptance confirms that the vendor agrees to fulfill the order at the specified fulfillment location.

2. The method of claim 1 wherein the order code is a text string entered via a keyboard of the communications device.

3. The method of claim 1 wherein the order code is a text string previously associated with a predefined order by the consumer.

4. The method of claim 1 wherein the translating operation comprises looking up the order code in a table to identify data for a vendor order message.

5. The method of claim 1 wherein the translating operation comprises:
generating the vendor order message to further specify the vendor.

6. The method of claim 1 wherein the translating operation comprises:
generating the vendor order message to further specify a fulfillment time.

7. The method of claim 6 wherein the acceptance further confirms that the vendor agrees to fulfill the order to satisfied the specified fulfillment time.

8. The method of claim 1 further comprising:
transacting a payment by the consumer for the order.

9. The method of claim 8 wherein at least a portion of the payment is credited to the vendor in exchange for the resource.

10. The method of claim 1 further comprising:
transmitting user interface communications to the communications device for prompting the consumer to provide additional information in association with the order.

11. The method of claim 10 further comprising:
receiving from the communications device a response to the user interface communications, wherein the response is used to alter the vendor order message transmitted to the vendor.

12. A computer-readable medium having computer-executable instructions for performing a computer process that implements the operations recited in claim 1.

13. A method of processing an order for a resource, wherein the order is initiated by a consumer through a communications device at an order location, the method comprising:
receiving from a communications device located at the ordering location an order message specifying the order;
generating a vendor order message based on the order message, wherein the vendor order message specifies the resource and a fulfillment location, and the order location differs from the fulfillment location;
transmitting the vendor order message to a vendor to request fulfillment of the order at the specified fulfillment location; and
receiving an acceptance of the order by the vendor, wherein the acceptance confirms that the vendor agrees to fulfill the order at the specified fulfillment location.

14. The method of claim 13 wherein the generating operation comprises:
generating the vendor order message to further specify the vendor.

15. The method of claim 13 wherein the generating operation comprises:
generating the vendor order message to further specify a fulfillment time.

16. The method of claim 15 wherein the acceptance further confirms that the vendor agrees to fulfill the order to satisfied the specified fulfillment time.

17. The method of claim 13 further comprising:
transacting a payment by the consumer for the order.

18. The method of claim 17 wherein at least a portion of the payment is credited to the vendor in exchange for the resource.

19. The method of claim 13 further comprising:
transmitting user interface communications to the communications device for prompting the consumer to provide additional information in association with the order.

20. The method of claim 19 further comprising:
receiving from the communications device a response to the user interface communications, wherein the response is used to alter the vendor order message transmitted to the vendor.

21. A computer-readable medium having computer-executable instructions for performing a computer process that implements the operations recited in claim 13.

22. A method of processing an order for a resource, wherein the order is initiated by a consumer through a communications device, the method comprising:
receiving from a communications device an order message specifying the order;
generating a vendor order message based on the order message, wherein the vendor order message specifies the resource, a vendor, a fulfillment location, and a desired fulfillment time;
transmitting the vendor order message to the specified vendor to request fulfillment of the order at the specified fulfillment location and the specified fulfillment time; and
receiving an acceptance of the order by the vendor, wherein the acceptance confirms that the vendor agrees to fulfill the order for the resource at the specified fulfillment location in compliance with the specified fulfillment time.

23. The method of claim 22 further comprising:
transacting a payment by the consumer for the order.

24. The method of claim 23 wherein at least a portion of the payment is credited to the vendor in exchange for the resource.

25. The method of claim 22 wherein the order message is initiated by the consumer at an order location that differs from the fulfillment location.

26. The method of claim 22 further comprising:
transmitting user interface communications to the communications device for prompting the consumer to provide additional information in association with the order.

27. The method of claim 26 further comprising:
receiving from the communications device a response to the user interface communications, wherein the response is used to alter the vendor order message transmitted to the specified vendor.

28. A computer-readable medium having computer-executable instructions for performing a computer process that implements the operations recited in claim 22.

29. An order processing computer system for processing an order for a resource, wherein the order is initiated by a consumer through a communications device, the order processing computer system comprising:
a message manager that receives from the communications device an order code associated with the order for the resource, the order code being entered by the consumer into the communications device;
an order code datastore associating a textual order code with the order;
an order validator that translates the order code to generate a vendor order message specifying the resource and a fulfillment location,
wherein the message manager further transmits the vendor order message to a vendor to request fulfillment of the order at the specified fulfillment location and receives an acceptance of the order by the vendor, and the acceptance confirms that the vendor agrees to fulfill the order at the specified fulfillment location.
